(19) United States
(12) Patent Application Publication
(10) Pub. No.: US 2005/0117025 A1
(43) Pub. Date: Jun. 2, 2005

(54) Image pickup apparatus, image pickup system, and image pickup method

(76) Inventors: Yasuhito Ambiru, Ome-shi (JP); Hiroshi Yoshimura, Saitama-shi (JP); Isao Ooshima, Kawasaki-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/805,245

(22) Filed: Mar. 22, 2004

(30) Foreign Application Priority Data
Mar. 31, 2003 (JP) 2003-095674

(51) Int. Cl. H04N 5/232

(52) U.S. Cl. 348/211.99

(57) ABSTRACT

An image pickup apparatus having image pickup sections which output a detection signal to which an exposure adjustment corresponding to a predetermined exposure signal is carried out with respect to incident light at the time of receiving the predetermined exposure signal, communication sections which communicate with the exterior, and a processing section which adds an exposure photometric range in a screen in accordance with a coordinate signal provided by a mouse or the like, and outputs it, and further generates a predetermined exposure signal corresponding to an image signal value within the exposure photometric range, and supplies it to the image pickup section, and outputs an image signal.

### CROSS-REFERENCE TO RELATED APPLICATIONS

This application is based upon and claims the benefit of priority from prior Japanese Patent Application No. 2003-095674, filed Mar. 31, 2003, the entire contents of which are incorporated herein by reference.

### BACKGROUND OF THE INVENTION

1. Field of the Invention

The present invention relates to an image pickup apparatus such as a network camera or the like, and in particular, to an image pickup apparatus, an image pickup system, and an image pickup method which carry out setting of an exposure photometric range of a network camera.

2. Description of the Related Art

Recently, accompanying popularization of digital equipment, a large number of types of picture-information machinery, such as a digital camera and the like, as well, have been developed and manufactured. In such a digital camera, the optimum exposure processing must be applied with respect to incident light from an object in various photographing situations, and as a prior art relating thereto, there is an example in which exposure is carried out with respect to image data at a predetermined focused portion in image pickup light (for example, Jpn. Pat. Appln. KOKAI Publication No. 2000-13675).

However, in the above-described prior art, a case is shown in which a screen of a digital camera is divided into, for example, nine, and for example, the lower central portion of the screen, or the like is selected, and exposure is carried out on the basis of the image in the region. However, the region cannot be designated in detail in this case. Namely, there is the problem that a region cannot be directly selected with respect to an object such as a person or the like in the screen, and the sufficient designation of a region cannot be carried out. Further, because the method for designating a region is carried out by the buttons of a camera or the like, there is the problem that the setting is difficult. Furthermore, in the above-described prior art, there is the problem that a method for designating a region with respect to a network camera or the like that carries out image pickup by a network is not concretely shown.

### BRIEF SUMMARY OF THE INVENTION

An aspect of the present invention is an image pickup apparatus comprising an image pickup section which picks up an image, a communication section which transmits the picked-up image to an external device, and which receives control information from the external device, and a processing section which, in a state in which the image is displayed on a display screen of the external device, when a predetermined region on the display screen is designated, generates and transmits image information to the external device via the communication section in order to display the predetermined region within the image, and applies exposure correction to the image to be picked up at the image pickup section on the basis of the predetermined region.

### BRIEF DESCRIPTION OF THE SEVERAL VIEWS OF THE DRAWING

FIG. 1 is a block diagram showing an embodiment of a configuration of an image pickup apparatus according to the present invention.

FIG. 2 is an explanatory diagram showing an example of a method for connecting the image pickup apparatus according to the invention and a network.

FIG. 3 is a cross-sectional view showing the embodiment of the configuration of the image pickup apparatus according to the invention.

FIG. 4 is a flowchart showing an example of a method for setting an exposure photometric range of the image pickup apparatus according to the invention.

FIG. 5 is a flowchart showing another example of the method for setting an exposure photometric range of the image pickup apparatus according to the invention.

FIG. 6 is an explanatory diagram showing an example of the operations of the method for setting an exposure photometric range of the image pickup apparatus according to the invention.

FIG. 7 is an explanatory diagram for explanation of the relationship between an image pickup possible screen AA and the exposure photometric range in the method for setting an exposure photometric range of the image pickup apparatus according to the invention.

### DETAILED DESCRIPTION OF THE INVENTION

Hereinafter, a network camera which is an image pickup apparatus according to the present invention will be described in detail with reference to the drawings.

Network Camera which is an Image Pickup Apparatus According to the Invention

(Configuration)

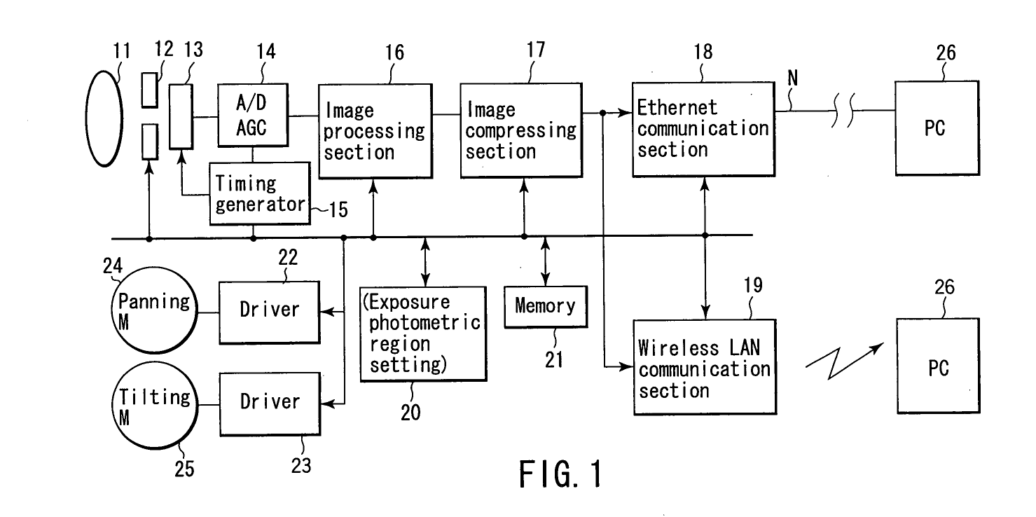

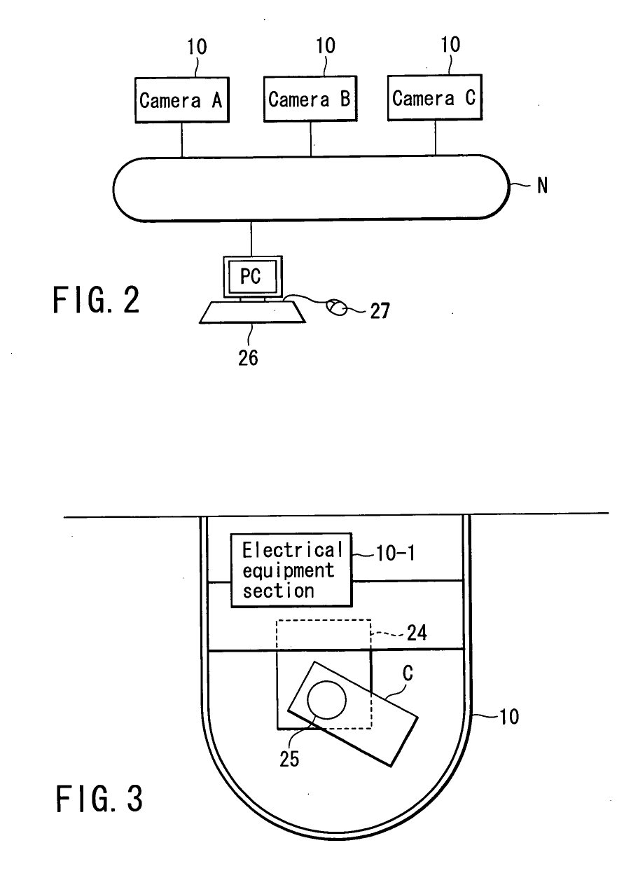

An image pickup apparatus and an image pickup system according to the invention will be described hereinafter by using the drawings, and by using the case of a PC (Personal Computer) connected to a network camera and a network as an example. FIG. 1 is a block diagram showing an embodiment of a configuration of the image pickup apparatus according to the invention, FIG. 2 is an explanatory diagram showing an example of a method for connecting the image pickup apparatus according to the invention and the network, and FIG. 3 is a cross-sectional view showing the embodiment of the configuration of the image pickup apparatus according to the invention.

As shown in FIG. 1, a network camera apparatus 10 which is the image pickup apparatus according to the invention has an objective lens 11, a mechanical iris mechanism 12 which receives incident light having passed through the objective lens 11, and which receives a control signal corresponding to a predetermined exposure value and carries out mechanical exposure adjustment in accordance with the control signal, and a solid image pickup element 13 which receives the incident light which has been exposure-adjusted and outputs a detection signal corresponding to the exposure-adjusted incident light, and which is formed from a CCD (Charge Coupled Device) or the like. Moreover, the solid image pickup element 13 receives a control signal for controlling timing of the converting processing when a detection signal is converted in accordance with the incident light from a timing generator 15, and carries out the converting processing. Exposure adjustment is possible by corresponding to the timing provided by the control signal. Moreover, the detection signal from the solid image pickup element 13 is supplied to an A/D converter/AGC (Auto Gain Controller) 14, and is converted into a digital signal, and the digital signal is further converted into an appropriate value in accordance with the control signal from the timing generator 15, and is outputted.

Moreover, the network camera apparatus 10 has an image processing section 16 which receives the output from the A/D converter/AGC circuit 14, and an image compressing section 17 which carries out compression processings such as MPEG compression, JPEG compression, or the like, with respect to an image signal which has been processed at the image processing section 16. At the image processing section 16, image processings such as, for example, sharpness processing, contrast processing, gamma correction, white balance processing, and pixel addition processing are applied with respect to the inputted image signal.

In addition, the network camera apparatus 10 has an MPU (Main Processing Unit) 20 and a memory 21. The MPU 20 controls the entire processing operations, and controls an exposure photometric region setting processing which is the feature of the present invention and which is described later. In the memory 21, a program that manages these operations is stored, and a work area for carrying out the respective processing operations with respect to the image signal is provided, and image data for alarm indication indicated at the time of movement detection or the like, and the like are stored.

Further, the network camera apparatus 10 has an Ethernet communication section 18 and a wireless LAN (Local Area Network) communication section 19 which are connected to the MPU 20 via a data bus, and carries out communication processing with, for example, a PC 26 at the exterior thereof, via a wire network N or a wireless network.

Moreover, the network camera apparatus 10 has a panning driver 22 for driving a camera unit C in the panning direction, a panning motor 24 such as a stepping motor or the like, a tilting driver 23 for driving the camera unit C in the tilting direction, and a tilting motor 25 such as a stepping motor or the like, which are connected to the MPU 20 via the data bus and are controlled by the MPU 20. Here, the camera unit C has at least the objective lens 11, the mechanical iris 12, and the solid image pickup element 13 described above.

As shown in FIG. 2, a plurality of the network camera apparatuses 10 can be provided via the network N. Moreover, driving processings, in the panning direction and the tilting direction, of the network camera apparatus 10 are possible by the PC 26 or the like, and furthermore, monitoring and recording/playback processing of the image signal picked up by the network camera apparatus 10 are possible. A pointing device such as a mouse is connected to the PC 26, and in particular, the PC 26 can easily carry out the exposure photometric range setting which will be described later.

Moreover, as shown in FIG. 3, the network camera apparatus 10 has the camera unit C, the panning motor 24 for driving the camera unit C in the panning direction, and the tilting motor 25 for driving the camera unit C in the tilting direction, and further has an electrical equipment section 10-1 having a configuration other than those shown in FIG. 1.

(Basic Operations)

The network camera apparatus 10 having such a configuration carries out basic operations as described hereinafter. Namely, the network camera apparatus 10 can carry out the image pickup operation in which incident light from an object is received and an image signal corresponding to the image picked-up screen is supplied via a network or the like, the camera driving operation in which a direction of the camera unit C is driven, for example, in the panning direction and the tilting direction, and further, the respective operation modes (for example, a movement detecting operation) based on the picked-up image signal, various types of setting operations such as setting of an exposure photometric range which will be described later, the self-testing operation, and the like.

Namely, the image pickup operation is carried out by the control of the MPU 20, in accordance with an operation program stored in the memory 21, due to an instruction signal being received from the PC 26 which is a control device, or the like, via the network N (or the wireless network). The solid image pickup element 13 having received the incident light from the object via the objective lens 11 supplies a detection signal corresponding to the incident light to the A/D converter circuit/AGC circuit 14.

Here, as an example, exposure adjustments are respectively carried out by the controls of the mechanical iris mechanism 12, the solid image pickup element 13, and the AGC circuit 14. Namely, the mechanical iris mechanism 12 receives an exposure control signal from the MPU 20, and carries out a desired exposure adjustment by controlling quantity of light which is taken therein. Further, the solid image pickup element 13 receives an exposure control signal from the MPU 20 in the same way, and carries out an exposure adjustment due to a timing signal being supplied from the timing generator 15 in accordance therewith, and by carrying out converting processing of the incident light into a detection signal in accordance with the timing. Furthermore, the AGC circuit 14 carries out exposure adjustment due to a control signal being supplied from the timing generator 15 having received the exposure control signal from the MPU 20 in the same way, and by controlling the gain of the detection signal supplied from the solid image pickup element 13 in accordance therewith. Further, here, as an example, the exposure adjustments at three stages are shown. However, the exposure adjustment is possible due to any one of these.

In the camera driving operation, after zero coordinate adjustment is carried out at the panning motor 24 and the tilting motor 25 which are the stepping motors, the MPU 20 always recognizes the current direction of the camera unit C. In accordance therewith, the MPU 20 always manages the coordinate of the screen which the camera unit C has currently picked up. At the same time when the image picked-up screen is changed due to the camera unit C being driven in the panning direction or the tilting direction in accordance with an operation control signal supplied to a driver from the MPU 20, the MPU 20 always recognizes the coordinate of the current image picked-up screen. Accordingly, while watching, from the screen of the PC 26 or the like connected via the network, the image picked-up screen which corresponds to the image signal which the image pickup apparatus 10 is currently continuing to supply, the user can move the camera unit C in the panning direction or the tilting direction, and can watch an image picked-up screen which corresponds to the movement. Further, the MPU 20 recognizes and manages the coordinates of the current image picked-up screen, and the user can acquire the coordinate information of the current image picked-up screen, for example, on the PC 26, in accordance with the operation.

In the respective operation modes, for example, the movement detecting operation mode, the image pickup apparatus 10 automatically detects a movement of an image within an arbitrary region set by the user. Namely, an observation region of the movement detection in the image picked-up screen is set in accordance with the operation by the user on the setting screen of the movement detecting operation mode. Thereafter, when variation greater than or equal to a predetermined value of the image picked-up screen is detected at the observation region during a set period, the MPU 20 determines that there is movement detection, and carries out, for example, a warning operation, i.e., an operation such as outputting an alarm signal, adding an alarm screen stored in the memory 21 to the image signal and outputting it.

(Setting Operation of Exposure Photometric Range)

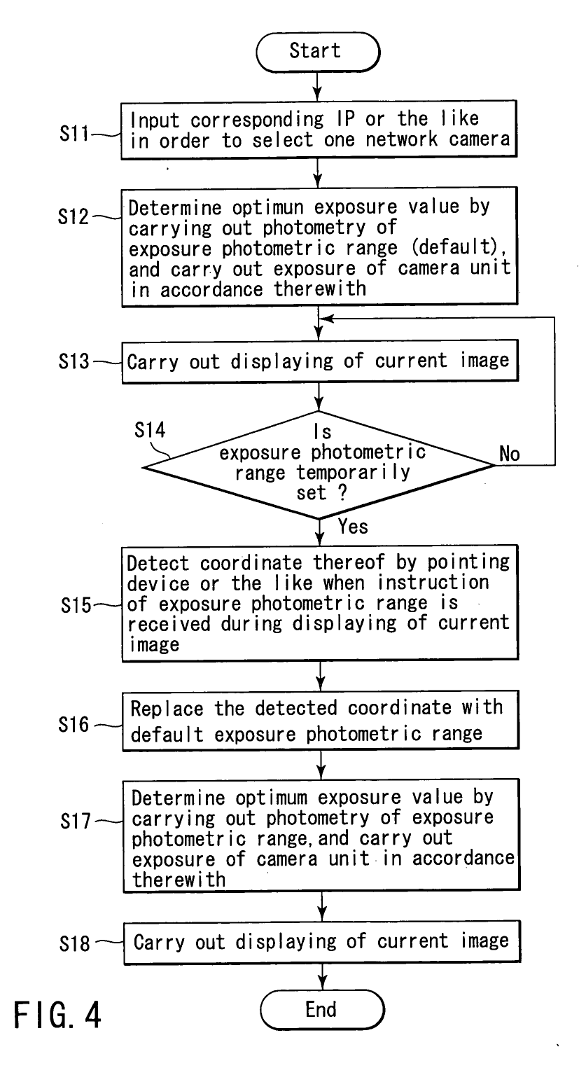

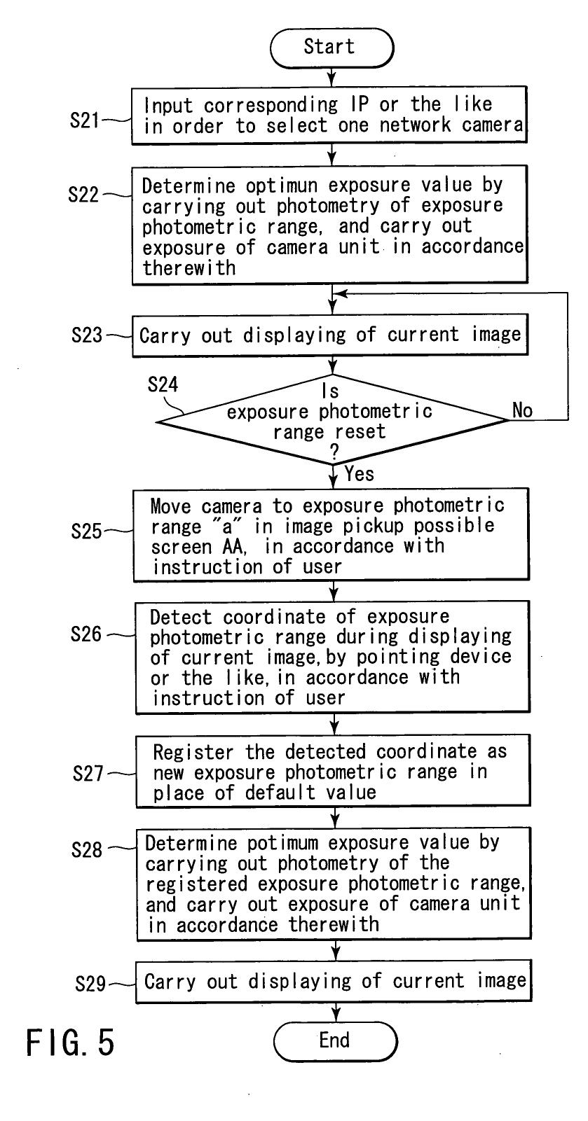

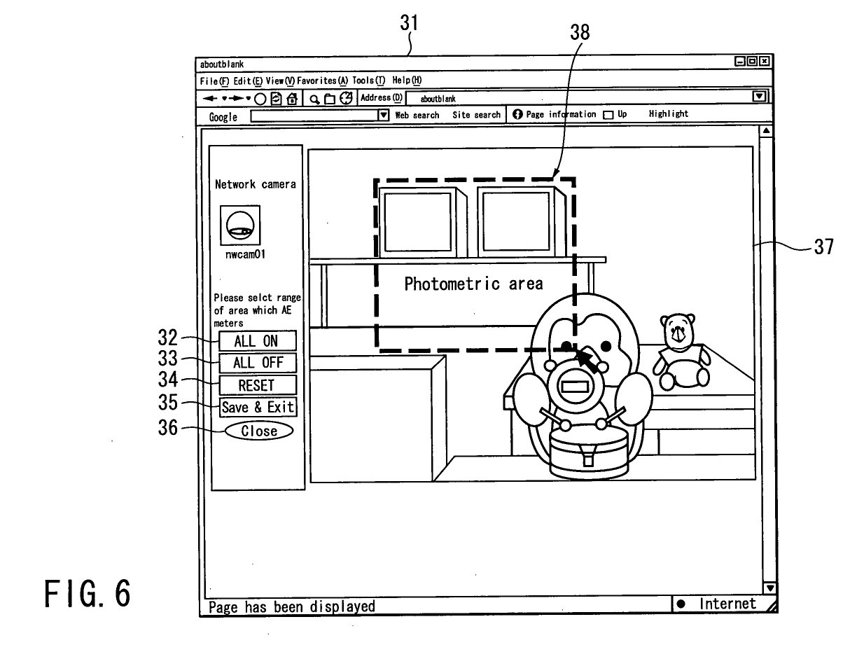

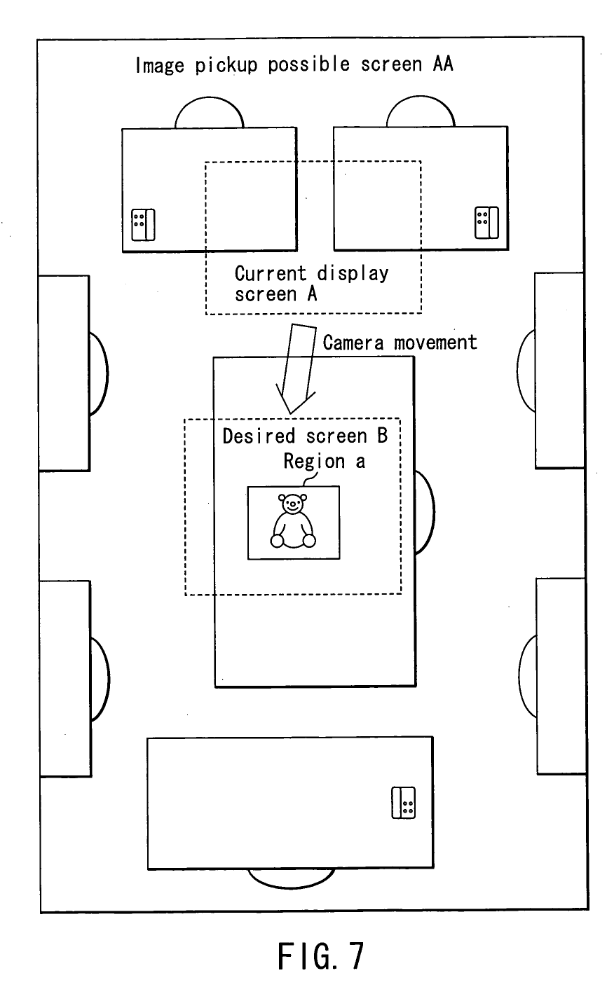

The setting operation of the exposure photometric range according to the invention in the image pickup apparatus 10 of the invention which carries out such basic operations will be described in detail hereinafter with reference to flowcharts. FIG. 4 is a flowchart showing an example of a method for setting an exposure photometric range of the image pickup apparatus according to the invention, FIG. 5 is a flowchart showing another example of a method for setting an exposure photometric range of the image pickup apparatus according to the invention, FIG. 6 is an explanatory diagram showing an example of the operation of a method for setting an exposure photometric range of the image pickup apparatus according to the invention, and FIG. 7 is an explanatory diagram for explanation of the relationship between an image pickup possible screen AA and the exposure photometric range in the method for setting an exposure photometric range of the image pickup apparatus according to the invention.

With respect to the setting for an exposure photometric range of the image pickup apparatus 10 according to the invention, at least two cases of a case in which the exposure photometric range is temporarily changed, and a case in which, due to the changed exposure photometric range being registered, an exposure adjustment is carried out in accordance with the exposure photometric range after being changed even after the camera unit C is moved, are possible.

Moreover, at the time of selecting an exposure photometric range 38, as shown in FIG. 7, at least two cases of a case in which the exposure photometric range 38 is set within the current display screen A which is currently being displayed, and a case in which, in the image pickup possible screen AA of a range in which pickup is possible within the range of the driving function of the image pickup apparatus 10, the screen is moved from the current display screen A to the desired screen B due to the camera unit C being moved from the panning direction to the tilting direction by the operation of the user, and an arbitrary region “a” in the desired screen B is set as the exposure photometric range 38, are possible.

(Temporary Range Setting in Current Display Screen a)

First, in the flowchart of FIG. 4, the range setting in the case in which the exposure photometric range 38 is temporarily changed in the current display screen A, will be described.

First, an IP address signal designated from a control device such as the PC 26 or the like on the network is supplied to the image pickup apparatus 10 according to the invention. When it is determined that the Ethernet communication section 18 or the wireless LAN communication section 19 of the image pickup apparatus 10 corresponds to the IP address, one image pickup apparatus 10 is operated under the control of the PC 26 or the like (S11). Here, when the image pickup apparatus 10 receives an instruction of the image pickup operation from the PC 26, the MPU 20 selects an exposure photometric range which is the default value, for example, an entire image picked-up screen or the like, determines an image signal value corresponding thereto, and decides an exposure value corresponding the image signal value. As a result, as described above, the MPU 20 carries out the exposure adjustment of the camera unit C by the mechanical iris mechanism 12, the solid image pickup element 13, the AGC circuit 14 and the like, by supplying a control signal for an exposure adjustment to the mechanical iris mechanism 12 and the timing generator 15 (S12).

With respect to the exposure adjustment here, as described above, there is no need to carry out all of the above-described three exposure adjustments, any one or two of those may be carried out. A detection signal corresponding to the incident light on which an exposure adjustment is carried out, is supplied as an image signal in the form of a digital signal which has been digital-converted, from the AGC circuit 14 to the image processing section 16. At the image processing section 16, image processings such as, for example, sharpness processing, contrast processing, gamma correction, white balance processing, and pixel addition processing are applied to the inputted image signal. Thereafter, MPEG compression or JPEG compression is applied thereto at the image compressing section 17, and the image signal is outputted via one of the Ethernet communication section 18 and the wireless LAN communication section 19. The outputted image signal is displayed as, for example, a screen of a browser application 31 shown in FIG. 6, after the expansion processing is applied thereto, for example, at the PC 26 (S13).

Here, when the mode of setting an exposure photometric range is selected by the user, at the screen of the browser application 31 as shown in FIG. 6, a current image picked-up screen 37 is displayed along with operation icons 32 to 36 at the operating region. Here, the operation icons are icons for the exposure photometric range setting modes, and an ‘ALL ON’ is an icon for making the entire screen be the exposure photometric range, an ‘ALL OFF’ is an icon for canceling the exposure photometric range on the entire screen, a ‘RESET’ is an icon for canceling the exposure photometric range designated by a pointing device such as a mouse, and for returning it to the default value, a ‘Save & Exit’ is an icon for determining the exposure photometric range designated by the pointing device such as a mouse, and for completing the exposure photometric range setting mode, and a ‘Close’ is an icon for closing the screen.

Now, when it is instructed from the PC 26 on the network that an exposure photometric range is set (S14), the MPU 20 detects a coordinate signal in which a coordinate signal of the pointing device of the PC 26 is provided to the image pickup apparatus 10 via the network or the like (S15). In accordance therewith, the MPU 20 makes the detected coordinate be an exposure photometric range replaced with the default value (current display image or the like) (S16), carries out photometry of the exposure photometric range in the image signal supplied from the AGC circuit 14 or the like, determines an optimum exposure value corresponding to the image signal value, and carries out the exposure adjustment by supplying the exposure control signal to the mechanical iris mechanism 12 or the timing generator 15, or the like (S17). In accordance therewith, displaying of the current screen is carried out by the exposure adjustment corresponding to the exposure photometric range designated by the pointing device (S18).

Here, on the setting screen of FIG. 6, the image within the exposure photometric range 38 as well is displayed, and it is possible for the user to provide an exposure adjustment which is optimum for the object, which the user wishes to clearly watch, to the entire screen by an extremely easy and intuitive operation. Accordingly, in FIG. 6, a state of the television screen shown in the screen can be displayed in a state in which the optimum exposure adjustment is carried out thereon.

Further, an operation mode in which, immediately after a range is selected by the mouse, an exposure adjustment on the selected exposure photometric range 38 is carried out, as well, is possible. However, for example, an operation mode in which an exposure adjustment is carried out after a determination signal of the icon 35 of ‘Save & Exit’ or the like is received from the PC 26, as well, is further possible within a range of the specification of the program stored in the memory 21.

Furthermore, in the mode of setting an exposure photometric range, when a temporary setting of an exposure photometric range is carried out, it is also preferable that, when a movement of the camera unit C is detected after an exposure-adjusted screen within the set exposure photometric range is displayed, the set exposure photometric range is cancelled, and an exposure photometric range of the default value is set.

(Registered Range Setting in Image Pickup Possible Screen AA)

Next, in the flowchart of FIG. 5, the case in which an arbitrary region is selected as the exposure photometric range 38 in the image pickup possible screen AA, and range setting is carried out by registering the exposure photometric range 38, will be described.

First, an IP address signal designated from a control device such as the PC 26 or the like on the network is supplied to the image pickup apparatus 10 according to the invention. When it is determined that the Ethernet communication section 18 or the wireless LAN communication section 19 of the image pickup apparatus 10 corresponds to the IP address, one image pickup apparatus 10 is operated under the control of the PC 26 or the like (S21). Here, when the image pickup apparatus 10 receives an instruction of the image pickup operation from the PC 26, the MPU 20 selects an exposure photometric range which is the default value, for example, an entire image picked-up screen or the like, determines an image signal value corresponding thereto, and decides an exposure value corresponding to the image signal value. As a result, as described above, the MPU 20 carries out the exposure adjustment of the camera unit C by the mechanical iris mechanism 12, the solid image pickup element 13, the AGC circuit 14 and the like, by supplying a control signal for the exposure adjustment to the mechanical iris mechanism 12 and the timing generator 15 (S22). The exposure-adjusted image information is outputted via one of the Ethernet communication section 18 and the wireless LAN communication section 19. The outputted image signal is displayed as, for example, a screen of the browser application 31 shown in FIG. 6, after the expansion processing is applied thereto, for example, at the PC 26 (S23).

Here, when the mode of setting an exposure photometric range is selected by the user, at the screen of the browser application 31 as shown in FIG. 6, the current image picked-up screen 37 is displayed along with operation icons 32 through 36 at the operating region.

Now, when it is instructed from the PC 26 on the network that an exposure photometric range is set and registered, it becomes the mode of setting an exposure photometric range (S24), and the user can select an arbitrary region a as the exposure photometric range within the image pickup possible screen AA as shown in FIG. 7. At this time, the user switches the screen from the current display screen A to the desired screen B by moving the camera unit C in the panning direction or the tilting direction (S25). Further, the coordinate of the exposure photometric range is designated due to the region “a” in the desired screen B being designated by using a pointing device such as a mouse. In accordance therewith, the MPU 20 of the image pickup device 10 detects the coordinate of the exposure photometric range, and displays the region in the same way as in the case of the exposure photometric range 38 of FIG. 6 (S26). Here, the user provides a determination signal from the PC 26 to the MPU 20 of the image pickup device 10 by operating, for example, the icon of ‘Save & Exit’ or the like of FIG. 6. In accordance therewith, the detected coordinate is replaced with the default value, and is registered as a new exposure photometric range (S27).

Thereafter, the MPU 20 makes the detected coordinate be the exposure photometric range replaced with the default value (current display image or the like), carries out photometry of the exposure photometric range in the image signal supplied from the AGC circuit 14 or the like, determines an optimum exposure value corresponding to the image signal value, and carries out the exposure adjustment by supplying the exposure control signal to the mechanical iris mechanism 12 or the timing generator 15 (S28). In accordance therewith, displaying of the current screen is carried out by the exposure adjustment corresponding to the exposure photometric range designated and registered by the pointing device (S29).

In this case as well, on the setting screen of FIG. 6, the image within the exposure photometric range 38 as well is displayed, and it is possible for the user to provide an exposure adjustment which is optimum for the object, which the user wishes to clearly watch, to the entire screen by an extremely easy and intuitive operation.

Further, the exposure adjustment by the exposure photometric range within the image pickup possible screen AA registered here is continued without being cancelled after the camera unit C is moved. In accordance therewith, for example, it is possible to organize a monitoring system which uses a network camera and is automated. Namely, in FIG. 7, even when the network camera C automatically and sequentially scans and monitors in a room within the range of the image pickup possible screen AA, monitoring of the object in the region a can be continued, in a state in which an exposure adjustment in which the object in the region a is clearly picked up is continuously insured.

At this time, even when the exposure photometric range does not exist in the screen due to the network camera C being moved in the panning direction or the tilting direction, it is preferable that the exposure adjustment is continues thereafter, for example, on the basis of a predetermined exposure signal generated in accordance with an image signal value in the exposure photometric range detected at the last time. Further, it is preferable that an average value of the image signal values within the past exposure photometric ranges is substituted therefor. Further, it is preferable that an exposure adjustment is carried out by the default value when the exposure photometric range does not exist within the current screen.

Furthermore, the PC 26 described as the control device on the network is merely one example, and the PC 26 can be a recorder for the digital images having the similar functions. In the same way, in accordance therewith, it is possible not only to carry out the image pickup operation, but also to record and playback a picked-up image.

In accordance with the various embodiments described above, those skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

As described above, in accordance with the present invention, an image pickup apparatus, an image pickup system, and an image pickup method which can carry out an exposure operation which is optimum for clearly displaying the object due to an object in an image picked-up screen being easily designated by using a pointing device such as a mouse in a control device such as a PC or the like by a network or the like, can be provided.

1. An image pickup apparatus comprising:
an image pickup section which picks up an image;
a communication section which transmits the picked-up image to an external device, and which receives control information from the external device; and
a processing section which, in a state in which the image is displayed on a display screen of the external device, when a predetermined region on the display screen is designated, generates image information and transmits it to the external device via the communication section in order to display the predetermined region in the image, and carries out an exposure correction with respect to the image to be picked up at the image pickup section on the basis of the predetermined region.

2. The image pickup apparatus according to claim 1, wherein, in a state in which the image is displayed on the display screen of the external device, when a predetermined region on the display screen is designated, the processing section generates image information and transmits it to the external device via the communication section in order to display the predetermined region in the image, and further carries out an exposure correction with respect to the image to be picked up at the image pickup section on the basis of the predetermined region after receiving a determination signal from the communication section.

3. The image pickup apparatus according to claim 1, wherein the exposure adjustment of the processing section is carried out by at least one method of an exposure adjustment in which incident light is limited by using an iris mechanism, an exposure adjustment carried out by controlling the operation timing of a solid image pickup element which receives the incident light and outputs a detection signal, and an exposure adjustment carried out by controlling the gain of the detection signal outputted from the solid image pickup element.

4. The image pickup apparatus according to claim 1, wherein the processing section displays the image within the designated predetermined region in the display screen, on the display screen of the external device in a state in which the user can distinguish in the same way as in the other region.

5. The image pickup apparatus according to claim 1, wherein the processing section distinguishes the predetermined region in accordance with a coordinate signal to be provided from a pointing device connected to the external device via the communication section.

6. The image pickup apparatus according to claim 1, further comprising:
an image compressing section which compresses the image picked up by the image pickup section in order to display the image by a browser application at the external device via the communication section.

7. The image pickup apparatus according to claim 1, further comprising:
at least one of a driving section which drives the image pickup section in the panning direction and a driving section which drives the image pickup section in the tilting direction.

8. The image pickup apparatus according to claim 7, wherein the processing section handles only a region in a current display screen showing the image picked up by the image pickup section, in accordance with a current position of the image pickup section by driving of the driving section, as the predetermined region.

9. The image pickup apparatus according to claim 8, wherein the processing section discontinues the exposure adjustment corresponding to the predetermined region when the image pickup section is moved by the driving section.

10. The image pickup apparatus according to claim 7, wherein the processing section can set the predetermined region within the range of an image pickup possible screen in which image pickup is possible by a movement of the image pickup section by the driving section, and thereafter, the processing section carries out an exposure adjustment on the basis of the predetermined region.

11. The image pickup apparatus according to claim 7, wherein the processing section can set the predetermined region within the range of an image pickup possible screen in which image pickup is possible by a movement of the image pickup section by the driving section, and after the setting, even if the predetermined region does not exist in the current display screen due to the movement of the image pickup section thereafter, the processing section carries out an exposure adjustment on the basis of the predetermined region.

12. The image pickup apparatus according to claim 7, wherein the processing section can set the predetermined region within the range of an image pickup possible screen in which image pickup is possible by a movement of the image pickup section by the driving section, and after the setting, even if the predetermined region does not exist in the current display screen due to the movement of the image pickup section thereafter, the processing section carries out an exposure adjustment on the basis of the predetermined region detected last.

13. An image pickup system having an image pickup apparatus and a control device which are connected by a network, and a communication section carrying out communication of both thereof, comprising:
the image pickup apparatus having an image pickup section which picks up an image, and a processing section which, in a state in which the image is displayed on a display screen of the control device, when a predetermined region on the display screen is designated, generates image information and transmits it to the control device via the communication section in order to display the predetermined region in the image, and carries out an exposure correction with respect to the image which is picked up at the image pickup section on the basis of the predetermined region; and
the control device which receives the image information from the image pickup apparatus via the communication section, and displays it, and which instructs the predetermined region to the processing section of the image pickup apparatus in accordance with the instruction of the user.

14. The image pickup system according to claim 13, wherein, in a state in which the image is displayed on the display screen of the control device, when a predetermined region on the display screen is designated, the processing section of the image pickup apparatus generates image information and transmits it to the control device via the communication section in order to display the predetermined region in the image, and further carries out an exposure correction with respect to the image to be picked up at the image pickup section on the basis of the predetermined region after receiving a determination signal via the communication section.

15. The image pickup system according to claim 13, further comprising:
at least one of a driving section which drives the image pickup section in the panning direction and a driving section which drives the image pickup section in the tilting direction.

16. The image pickup system according to claim 13, wherein the processing section of the image pickup apparatus can set the predetermined region within the range of an image pickup possible screen in which image pickup is possible by a movement of the image pickup section by the driving section, and thereafter, the processing section of the image pickup apparatus carries out an exposure adjustment on the basis of the predetermined region.

17. An image pickup method comprising:
picking up an image; and
in a state in which the image is displayed on a display screen of an external device via a network, when a predetermined region on the display screen is designated, generating image information and transmitting it to the external device via the network in order to display the predetermined region in the image, and carrying out an exposure correction with respect to the image to be picked up on the basis of the predetermined region.

18. The image pickup method according to claim 17, wherein, when a predetermined region on the display screen is designated, the exposure correction generates the image information and transmits it to the external device via the network, and after receiving a determination signal in accordance therewith, the exposure correction is carried out.

19. The image pickup method according to claim 17, wherein, when the image pickup section which picks up the image is moved at least in one of the panning direction and the tilting direction, the exposure adjustment based on the predetermined region is discontinued.

20. The image pickup method according to claim 17, wherein the predetermined region is set within the range of an image pickup possible screen in which image pickup is possible by moving the image pickup section which picks up the image at least in one of the panning direction and the tilting direction, and after the setting, the exposure adjustment is continued on the basis of the predetermined region regardless of the movement of the image pickup section.
